(19) United States
(12) Patent Application Publication
(10) Pub. No.: US 2026/0170668 A1
(43) Pub. Date: Jun. 18, 2026

(54) MULTI-HYPOTHESIS 2D TO 3D IMAGE REGISTRATION

(71) Applicant: Raytheon Company, Arlington, VA (US)

(72) Inventors: Brett N. Appleton, Centreville, VA (US); Jody D. Verret, Rockwall, TX (US); Richard W. Ely, Lewisville, TX (US)

(21) Appl. No.: 18/984,350

(22) Filed: Dec. 17, 2024

(51) Int. Cl. G06T 7/33; G06T 7/32

(52) U.S. Cl. CPC G06T 7/337; G06T 7/32; G06T 2207/10028; G06T 2207/20076

(57) ABSTRACT

Devices, systems, and methods for image processing are provided. A method can include generating, based on metadata of the 2D real image, hypotheses metadata, different hypothesis metadata of the hypotheses metadata corresponding to different image geometries, the different image geometries corresponding to different image platform locations, generating, based on respective hypothesis metadata of the hypotheses metadata, hypothesis images for different platform locations, registering the 2D real image and the hypothesis images to the 3D point set, selecting, based on one or more accuracy factors, the hypothesis image of the hypothesis images that has a best registration to the 3D point set resulting in a selected hypothesis image, and altering the metadata of the 2D real image based on the image geometry of the metadata of the selected hypothesis image.

### TECHNICAL FIELD

Embodiments discussed herein regard devices, systems, and methods for image registration to a three-dimensional (3D) point set. Embodiments can be agnostic to image type.

### BACKGROUND

Applications of accurate registration to a 3D source include cross-sensor fusion, change detection, 3D context generation, geo-positioning improvement, target locating, target identification, or the like.

### BRIEF DESCRIPTION OF THE DRAWINGS

FIG. 1 illustrates, by way of example, a flow diagram of an embodiment of a method for 2D real image registration to a 3D point set.

FIG. 2 illustrates, by way of example, a diagram of an embodiment of a grid of multiple platform location hypotheses.

FIG. 3 illustrates, by way of example, a diagram of an embodiment of the grid after the method of FIG. 1 is performed.

FIG. 4 illustrates, by way of example, a diagram of an embodiment of a real image and some corresponding hypothesis images.

FIG. 5 illustrates, by way of example, a diagram of an embodiment of a method for registering a 2D real image to a 3D point set.

FIG. 6 illustrates, by way of example, a block diagram of an embodiment of a machine in the example form of a computer system within which instructions, for causing the machine to perform any one or more of the methodologies discussed herein, may be executed.

### DETAILED DESCRIPTION

Various embodiments described herein regard registering a two-dimensional (2D) real image to a three-dimensional (3D) point set. The real image can be from an image sensor. The image sensor can include a synthetic aperture radar (SAR), electro-optical (EO), multi-spectral imagery (MSI), panchromatic (PAN), infrared (IR), nighttime EO, visible, nighttime visible, or another image sensor.

There are many instances in which image metadata is inaccurate. Location data in the image metadata can be inaccurate. The location data indicates a location at which an image was collected. Accurate registration of 2D imagery to foundational 3D data has several other use cases including global positioning system (GPS) denied navigation, terrain avoidance, and enhanced change detection. 2D-3D registration recovers geolocation errors in the 2D imagery relative to the 3D data, but if the initial errors are too large the heritage/classical registration process will fail. Large geolocation errors can be present for multiple reasons, such as geolocation drift, inaccurate sensor metadata, and lack of GPS availability.

Large geolocation error in this context means that the metadata errors are so large that there is very little (if any) overlap between the real image ground locations and the image ground locations established from an image generated based on a platform location indicated by the metadata. Very little overlap implies that registration of a real image to a ground reference surface simply based on the metadata is certain to fail—there is insufficient common ground intersection between the real image and a ground reference image.

The registration process herein describes a mechanism for overcoming large geolocation errors by perturbing metadata of an image until the true image ground location and metadata-derived ground location do overlap for some particular perturbation values. Classical registration techniques for the “correctly perturbed” metadata thus allows for a successful registration. Each metadata perturbation is denoted a “hypothesis” of the true error. If many hypotheses are used for registration, the hypothesis with the best registration accuracy is likely to be the correct estimate of the true (large) geolocation error.

Embodiments provide ways to successfully perform 2D-3D registration in the presence of large unknown geolocation errors. The embodiments can be used, for example, in GPS denied navigation environments where large geolocation errors can result from position error drift.

In an example, the registration includes forming a plurality of “hypothesis synthetic images” by projecting points of the 3D point set to an image space comprised of a set of hypothesis metadata-indicated locations of the 2D real image. The result of the projecting is a plurality of synthetic images, one at each hypothesis location. Each hypothesis location is a potential location that is closest to the actual location at which the image was captured. Pixel intensities of each of the synthetic images can be populated with the image intensity attribute for each point contained in the point set. A set of tie points (TPs) (that can be converted to control points (CPs)) can be extracted for each synthetic image. The CPs, which are derived from the 3D point set and the TPs, can be used in a photogrammetric bundle adjustment to bring the 2D real image into alignment with the 3D source. A best hypothesis can be selected based on registration metrics. The location corresponding to the best hypothesis (or a combination of the best hypotheses) can be used as a greatly improved estimate of the true location of the 2D real image.

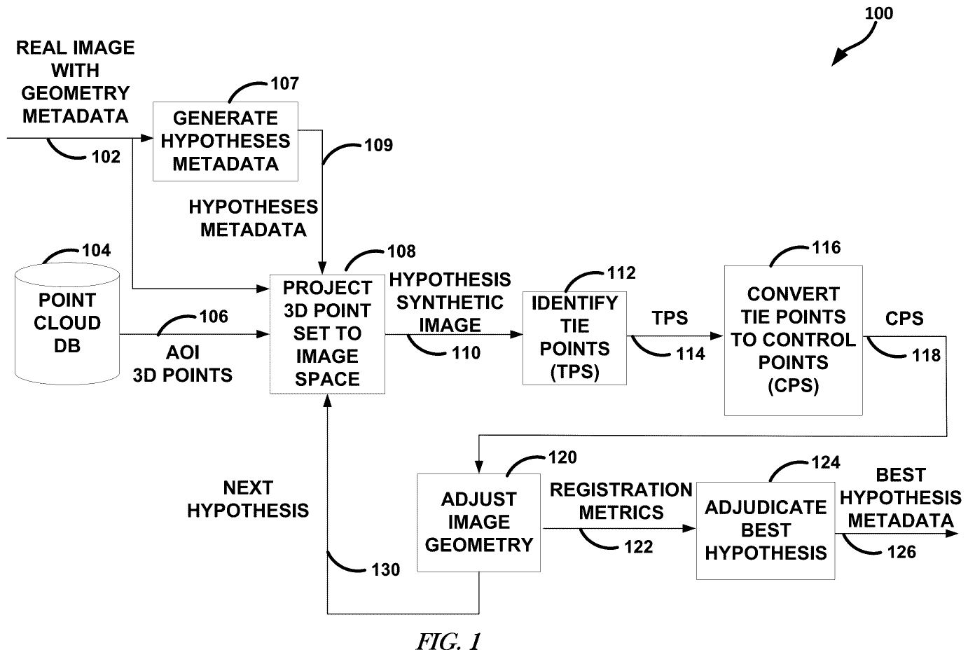

FIG. 1 illustrates, by way of example, a flow diagram of an embodiment of a method 100 for 2D real image registration to a 3D point set. The method 100 includes receiving or obtaining real image 102 and a 3D point set 104. The real image 102 can be from a SAR, EO, panchromatic, IR, MSI, nighttime EO, visible, nighttime visible, or another image sensor. The image sensor may be satellite based, located on a manned or unmanned aerial vehicle, mounted on a moveable or fixed platform, or otherwise positioned in a suitable manner to capture the real image 102 of a region of interest. The 3D point set 106 can be extracted from a point cloud database (DB) 104. The 3D point set 106 can be of a geographical region Area of Interest (AOI) that overlaps with a geographical region depicted in the real image 102. In some embodiments, the 3D point set 104 can be of a geographical region that includes the entire geographical region depicted in the real image 102. In some embodiments, the 3D point set 104 can cover a larger geographical region than the geographical region depicted in the real image 102.

At operation 107, multiple hypotheses metadata 109 are generated. The hypotheses metadata 109 is generated by a plurality of perturbations of the geolocation metadata of the image 102. The dimensions or spacing between the multiple hypotheses metadata can be determined based on the maximum error recoverable by the registration algorithm, the maximum expected error in the geolocation of the image 102, or a combination thereof. The perturbations in the metadata can include changing one or more parameter values. The parameter values can include latitude, longitude, platform height, roll, pitch, yaw, a combination thereof, or the like. By not perturbing a parameter value, one assumes that the error for that parameter is small or otherwise negligible.

The image registration can occur in an overlap between the 3D points 106 and the hypotheses metadata 109. The 3D point set data 106 in the overlap (plus an uncertainty region) can be provided as input to operation 108. The overlap can be determined by identifying the minimum (min) and maximum (max) X and Y of the extent of the 3D point set intersected with the min and max X and Y of the hypotheses metadata 109, where X and Y are the values on the axes of a geometric coordinate system of the hypotheses metadata 109.

The operations 108, 112, 116, and 120 of FIG. 1 are a technique for registering a particular hypothesis of the hypotheses metadata 109 to corresponding AOI 3D points 106. The operations 108, 112, 116, and 120 are merely examples as there are other techniques for registering 2D image data to a 3D point set. Each particular hypothesis is used to perform the registration in operations 108,112,116 and 120. The process is repeated (see 130) for each hypothesis in the hypotheses metadata 109. Registration via many hypotheses metadata 109 to the AOI 3D points 106 results in registration metrics 122. The registration metrics 122 is a plurality of metrics from all hypotheses at different metadata perturbations. The hypothesized registration metrics can be adjudicated at operation 124 to identify a selected best hypothesis 126. First, some example techniques for registering the hypothesis synthetic image 110 to the AOI 3D points 106 is provided and followed by examples of adjudicating at operation 124.

The operation 108 can include establishing a scale of the hypothesis synthetic image 110 and its geographical extent. The scale can be computed as a point spacing of the 3D point set 106 or as a poorer of the point spacing of the 3D point set 106 and the X and Y scale of the synthetic image 110. The geographical extent of the hypothesis synthetic image 110 can be determined by generating an X, Y convex hull of the 3D point set 106 and intersecting it with a polygon defined by X, Y coordinates of the extremes of the particular hypothesis metadata. The minimum bounding rectangle of this overlap region can define an output space for the hypothesis synthetic image 110.

At operation 108, the 3D point set 106 can be projected to an image space of a particular hypothesis of the hypotheses metadata 109 to generate the hypothesis synthetic image 110. The particular hypothesis metadata can include geometry and other data, such as a look angle, focal length, orientation, the parameters of a perspective transform, the parameters and coefficients of a rational polynomial projection (e.g., XYZ-to-image and/or image-to-XYZ), or the like.

If more than one point from the 3D point set 106 projects to a same pixel of the hypothesis synthetic image 110, the intensity of a point from the 3D point set 106 that is closest to the sensor position can be used. This assures that only points visible in the collection geometry of a particular hypothesis is used in the hypothesis synthetic image 110. Points that project outside the computed geographic overlap (plus some uncertainty region) can be discarded.

Each point in the 3D point set 106 can include an X, Y, Z coordinate, and color value (e.g., a grayscale intensity, red, green, blue intensity, or the like). In some embodiments a median of the intensities of the pixels that the point represents in all the images used to generate the 3D point set 106 can be used as the color value.

A geometry of an image can be determined based on a location, orientation, focal length of the camera, the parameters of a perspective transform, the parameters and coefficients of a rational polynomial projection (e.g., image-to-XYZ or XYZ-to-image projection or the like), and/or other metadata associated with the imaging operation.

At operation 112, tie points (TPS) 114 can be identified in the hypothesis synthetic image 110. A TP is a four-tuple (row from synthetic image 110, column from hypothesis synthetic image 110, row of the real image 102, column of the real image 102).

The operation 112 can include operating an edge-based technique on an image tile to generate an edge pixel template for the hypothesis synthetic image 110 to be correlated with the gradient of the real image 102. An edge pixel template can include a gradient magnitude and phase direction for each edge pixel in an image tile. The edge pixel template can include only high contrast edges (not in or adjacent to a void in the hypothesis synthetic image 110). Alternatives to edge-based correlation techniques include fast Fourier transform (FFT), or normalized cross correlation (NCC), among others.

In some embodiments, the operation 112 can include a two-step process, coarse registration followed by fine registration. The coarse registration can operate on a plurality image tiles (subsets of contiguous pixels of the hypothesis synthetic image 110). The plurality of image tiles can span the entirety of the hypothesis synthetic image 110. When the hypothesis synthetic image 110 is formed it may be misaligned with the real image 102 due, at least in part, to inaccuracy in the geometric metadata associated with the image data 102.

A registration search uncertainty can be set large enough to ensure that the hypothesis synthetic image 110 can be registered with the real image 102. The term coarse registration offset means a registration offset that grossly aligns the hypothesis synthetic image 110 with the real image 102. To make the registration efficient and robust an initial registration can determine the coarse registration offset and remove the same. The fine registration can then operate within a smaller uncertainty region. The coarse registration can employ a larger uncertainty search region to remove a misalignment error, or misregistration, between the hypothesis synthetic image 110 and the real image 102. Fine registration can use a smaller image tile size (and image template size) and a smaller search region to identify a set of TPS 114. The TPS 114 can be converted to CPs at operation 116. The fine registration can be performed after correcting alignment or registration using the coarse registration.

In both registration steps, a same or similar technique may be used to independently register each image tile. The fine registration can use a smaller tile size and a smaller search region. The operation 112 can include identifying pixels of the hypothesis synthetic image 110 corresponding to high contrast edge pixels. Identifying pixels of the synthetic image 110 corresponding to high contrast edge pixels can include using a Sobel, Roberts, Prewitt, Laplacian, or other operator. The Sobel operator (sometimes called the Sobel-Feldman operator) is a discrete differentiation operator that computes an approximation of the gradient of an intensity image. The Sobel operator returns a gradient vector (or a norm thereof) that can be converted to a magnitude and a phase. The Roberts operator is a discrete differentiation operator that computes a sum of the squares of the differences between diagonally adjacent pixels. The Prewitt operator is similar to the Sobel operator. The operation 112 can include correlating phase and magnitude of the identified high contrast edge pixels, as a rigid group, with phase and magnitude of pixels of the hypothesis synthetic image 110.

To ensure that not all the edge pixels in the tile are running in the same direction (have gradients with same phase), the operation 112 can include computing two thresholds on the gradient magnitude, one for pixels whose gradient phase is near a principal phase direction and one for pixels not in the principal phase direction. The threshold for edges not in the principal phase direction can be lower than the threshold for edges in the principal phase direction. Edge correlation of the operation 112 can include summing over all the high contrast edge pixels of the gradient magnitude of the image times the gradient phase match between the hypothesis synthetic image 110 and the real image 102.

Edge pixels associated with voids in the hypothesis synthetic image 110 can be suppressed and not used in the correlation with the real image 102. The real image 102 has no voids so the gradients of all pixels of the image can be used.

One aspect of the method 100 is how the TPS 114 from coarse or fine registration are used to determine an offset for each tile between the hypothesis synthetic image 110 and real image 102. A synthetic image edge pixel template can be correlated as a rigid group (without rotation or scaling, only translation) with a gradient magnitude and phase of the hypothesis image data. A registration score at each possible translation offset can be determined. The registration scores can be determined as a weighted sum of the scores from each offset in each of the tiles. More details regarding the score are provided elsewhere.

While the method 100 is tolerant to blunders in the correlation of individual tiles, an offset from the coarse registration must be calculated correctly or there is a risk of not being able to perform fine registration. Since the fine registration can use a smaller search radius, an error in the offset may cause the correct correlation location to be outside the search radius of the fine registration, therefore causing fine registration to be unable to correlate correctly.

At operation 116, the TPS 114 are converted to CPS 118 using the 3D point set 106 from which the synthetic image 110 was produced. The CPS 118 are five-tuples (row of the real image 102, column of the real image 102, X, Y, and Z). The XYZ coordinate of CPS 118 can include an elevation corresponding to a top of a building. The registration provides knowledge of the proper point in the 3D point set 106 corresponding to image coordinates in the real image 102.

The TPS 114 can be associated with a corresponding closest point in the 3D point set 104 to become CPS 118. The TPS 114 can be associated with an error covariance matrix that estimates the accuracy of the registered TP 114. An index of each projected 3D point from the 3D point set 104 can be preserved when creating the synthetic image 110 at operation 108. A nearest 3D point to the center of a tile associated with the TP 114 can be used as a ground (XYZ) coordinate for the CP 118. The error covariance can be derived from a shape of a registration score surface at a peak, one or more blunder metrics, or a combination thereof.

At operation 120, the geometry of a particular hypothesis can be adjusted (e.g., via a least squares bundle adjustment, or the like) to bring the particular hypothesis metadata (and thus the synthetic image 110) into geometric alignment with real image 102. The photogrammetric geometric bundle adjustment can include a nonlinear, least squares adjustment to reduce (e.g., minimize) misalignment between the CPs 118.

The hypothesis synthetic image 110 may be of poorer resolution than the real image 102 and may not be at the same absolute starting row and column as the real image 102. The adjusted geometry performed in 120 can be used to create a projection for the hypothesis synthetic image 110 that is consistent with the absolute offset and scale of the real image 102.

After the operation 120 completes, the geometry of the particular hypothesis can be updated to match the registered control (the 3D point set). As long as the errors of the TPS 114 are uncorrelated, the adjusted geometry is more accurate than the TPS 114 themselves. A registration technique using CPS (e.g., a known XYZ location and a known image location for that location) can be used to perform operation 120. From the CPS 118, the imaging geometry of the particular hypothesis image 110 can be updated to match the geometry of the CPS 118.

Adjusting the geometry of a particular hypothesis (the operation 120) is now summarized. Image metadata can include an estimate of the sensor location and orientation at the time the image was collected, along with camera parameters, such as focal length. If the metadata was perfectly consistent with the 3D point set 106, then every 3D point would project exactly to the correct spot in the synthetic image 110. For example, the base of a flagpole in the 3D point set 106 would project exactly to where one sees the base of the flagpole in the real image 102. But, in reality, there are inaccuracies in the metadata of the real image 102 and the corresponding hypothesis. If the estimate of the camera position or orientation is in error, then the 3D point representing the base of the flagpole will not project exactly to the pixel of the base in the real image 102. But with the adjusted geometry, the base of the flagpole will project very closely to where the base is in the real image 102. The result of the registration is adjusted geometry for the particular hypothesis. Any registration process can be used that results in an adjusted geometry for the particular hypothesis being consistent with the 3D point set 106.

The result of performing the registration for each particular hypothesis in the hypotheses metadata set 109 is a set of registration metrics (one metric for each hypothesis). The plurality of these registration metrics is provided to operation 124.

The operation 124 can include determining a plurality of accuracy factors for each particular hypothesis. The accuracy factors can include a registration blunder metric, a number of CPs produced at operation 116, a median pixel shift between TPs of the real image 102 and a respective hypothesis synthetic image 110, a median pixel discrepancy when projecting the CPs using the adjusted geometry, a combination thereof, or the like. The operation 124 can include determining a mathematical combination of the registration factors to determine a score.

The registration blunder metric can be determined based on a phase match value (e.g., an average phase match value (“avgphasematch”), a peak correlation ratio (“pkratio”), or a combination thereof. A combination of these values can be determined as (1−pkratio)*(avgphasematch), where pkratio is the ratio of the second highest peak correlation score to the highest peak correlation score and the avgphasematch is the average phase match. The avgphasematch is the average phase match of the correlation edges between the gradient of a hypothesis image and the gradient of the real image 102 (measured at the registration offset associated with the top peak). A higher edge gradient phase match value indicates a better image registration. A lower pkratio value indicates a better image registration.

The number of CPs produced is relative to the scene being imaged and is higher for scenes with more definite edges or objects. CPs are points that are required to be in both the hypothesis image and the real image 102 so more CPs indicate a better registration.

The median pixel shift between tie points is the amount of movement, in terms of number of pixels, a real number or integer, moved to register the hypothesis image to the real image 102. A larger median pixel shift between tie points can be indicative of a worse hypothesis.

The median pixel discrepancy can be described with some background explanation. The TPs 114 can be converted to CPs 118 because the ground location of every pixel in the hypothesis synthetic image 110 produced from the 3D point set 104 is known. Each CP 118 consists of a ground point and the pixel location in the hypothesis synthetic image 110 corresponding to that ground location. The CPs 118 can be used to adjust the geometry of the image 102 so that it aligns with the hypothesis synthetic image 110 produced by the 3D point set 104. If the CP 118 is very accurate, then the ground point associated with the CP 118 should project close to the pixel location of the CP 118 when using the adjusted geometry for the projection. The pixel distance between the image location and the pixel location of the projected ground location is the “discrepancy” of the CP 118. A hypothesis that produces CPs 118 with large discrepancies means that either the registration produced poorly positioned CPs 118 or the geometric adjustment was poor (possibly due to very poor starting geometry) or both. So the smaller the median discrepancy, the more likely it is that the hypothesis produced an accurate registration,

There are many ways to combine these registration factors to determine a score. One known way that works well for selecting a best hypothesis image is determining the following score and then selecting the hypothesis image with the highest score:
registration blunder metric*sqrt (minimum (25, number of CPs))/(maximum (8.0, (tie point pixel shift)*maximum (2, CP discrepancy))

A multi-hypothesis image registration method in accord with embodiments starts by generating a grid of hypothesis points. There is one point corresponding to a location indicated by the image metadata of the image and the remaining points are hypothesis point, each of which has perturbed “error” added to the real 2D image's geolocation metadata (or platform location). The goal of doing image-to-3D registration is to determine the true imaging platform location (and therefore true image ground location), and each of the hypothesis points is effectively a coarse guess at what that location is. The idea is that one or more of these guesses will be “close enough” and allow for successful registration.

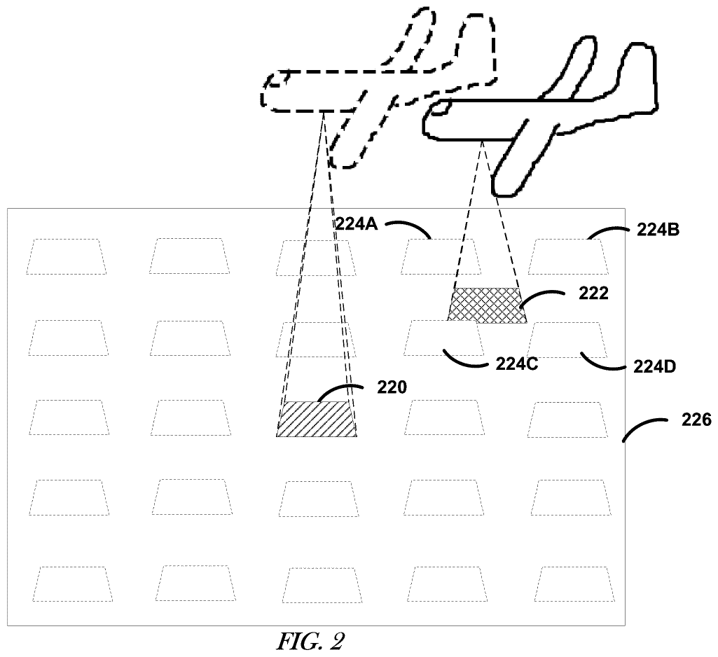

FIG. 2 illustrates, by way of example, a diagram of an embodiment of a grid 226 of image platform locations. Note that the grid 226 in FIG. 2 includes platform location hypotheses that are non-overlapping to help with visualization and understanding. Usually, there will be overlap between hypotheses. The grid 226 includes the true image platform location 222 which resulted in collection of the real image 102. The image platform locations include:
(i) the true image platform location 222 corresponding to the true imaging platform location when the real image 102 was collected. Note that this true platform location is not known in advance, but is approximated by the method 100;
(ii) an image platform predicted location 220 corresponding to a location indicated by the metadata of the real image 102;
(iii) a plurality of hypothesis image platform locations 224A, 224B, 224C, and 224D. Note that not all platform locations for all hypotheses are labeled. Each unfilled trapezoid “footprint” corresponds to a different hypothesis image platform location.

The operation 107, alters the metadata of the real image 102 to generate hypotheses metadata 109 with hypothetical image platform locations 224A-224D. Altering the metadata can include altering one or more parameters in the metadata that influence the corresponding image platform locations 224A-224D. The parameters can include latitude, longitude, platform height, roll, pitch, yaw, or the like.

The real image pixels 102 used for registration for each hypothesis do not change; only the metadata differs between each hypothesis (and thus the hypothesis synthetic image 110 pixels vary). Operation 108 projects the 3D data 106 to image space for each hypothesis synthetic image 110, using the updated metadata for each hypothesis. Operation 112 then identifies TPs between corresponding image pairs in images 102 and 110. The operation 124 is then performed on each of the respective hypothesis images to identify the best hypothesis 126.

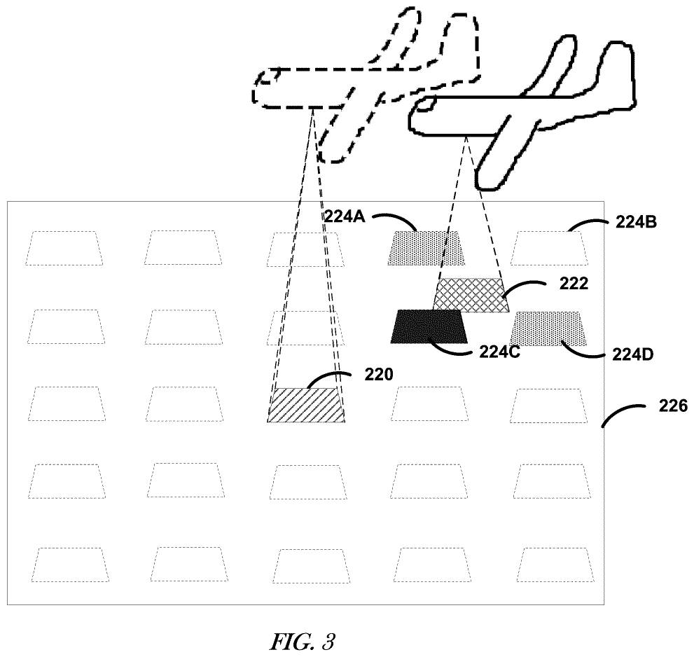

FIG. 3 illustrates, by way of example, a diagram of an embodiment of the grid 226 after the method 100 is performed. Using the method 100, the platform location 224C is adjudicated as corresponding to the most accurate representation of the location of the real image 102 among the platform locations of the hypothesis images and the real image 102. The metadata of the hypothesis image corresponding to the platform location 224C can replace the corresponding metadata of the real image 102. The platform location 224C can be used as the location of the sensor that generated the real image 102.

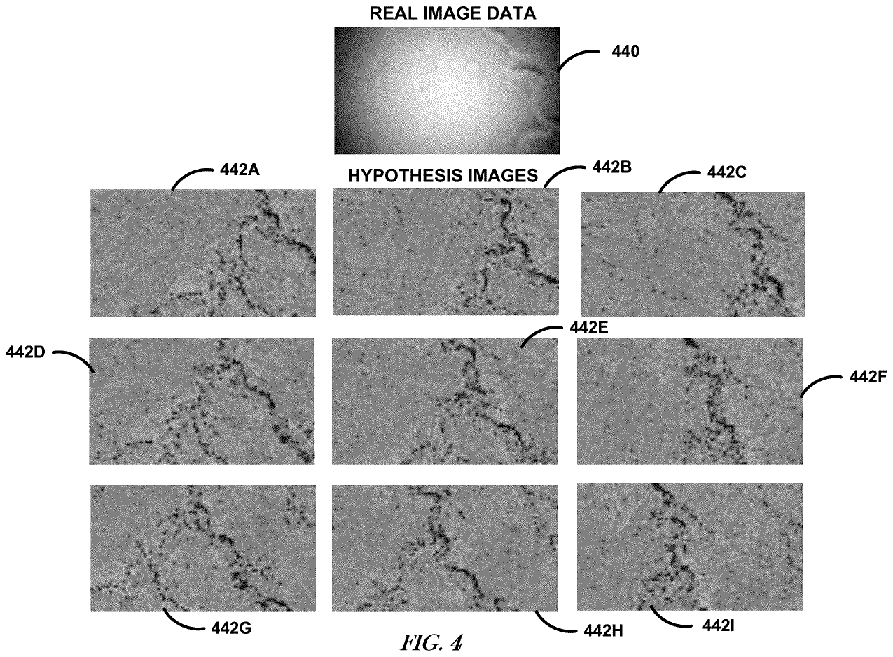

FIG. 4 illustrates, by way of example, a diagram of an embodiment of a real image 440 and some corresponding hypothesis synthetic images 442A, 442B, 442C, 442D, 442E, 442F, 442G, 442H, 442I (which are examples of generated hypothesis synthetics images, 110). The method 100 is performed on the real image 440 and the hypothesis synthetic images 442A-442I. Using the method 100, the hypothesis synthetic image 442C is deemed the best hypothesis synthetic image in terms of location based on the registration metrics 122 as evaluated by operation 124.

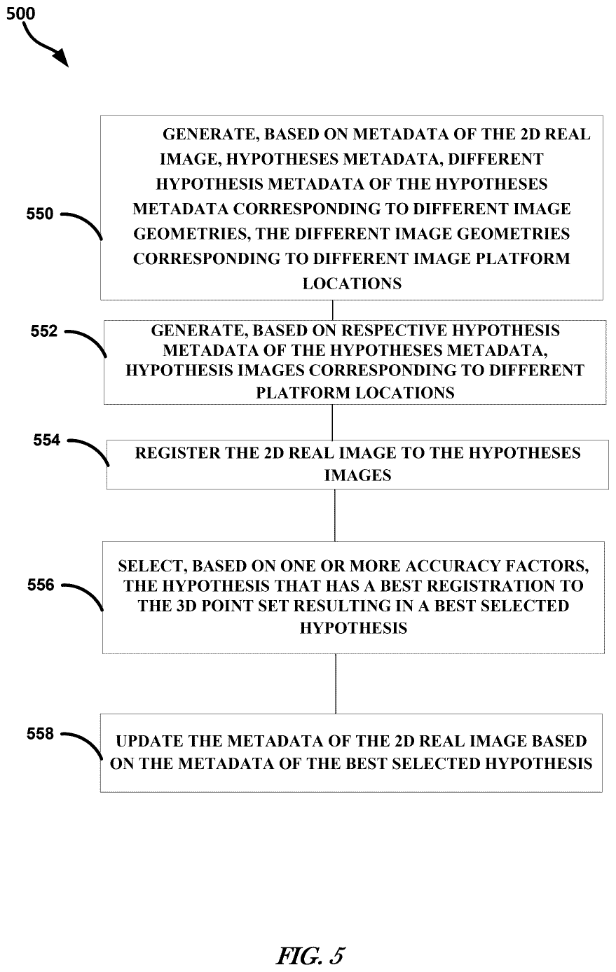

FIG. 5 illustrates, by way of example, a diagram of an embodiment of a method 500 for registering a 2D real image to a 3D point set. The method 500 as illustrated includes generating, based on metadata of the 2D real image, hypotheses metadata, different hypothesis metadata of the hypotheses metadata corresponding to different image geometries, the different image geometries corresponding to different image platform locations, at operation 550; generating, based on respective hypothesis metadata of the hypotheses metadata, hypothesis images for different platform locations, at operation 552; registering the 2D real image and the hypotheses images formed from the 3D point set, at operation 554; selecting, based on one or more accuracy factors, the particular hypothesis of the plurality of hypotheses that has a best registration to the 3D point set resulting in a selected best hypothesis, at operation 556; and updating the metadata of the 2D real image based on the geolocation of the selected best hypothesis image, at operation 558.

In the method 500 and FIGS. 2 and 3, the parameter values perturbed include platform location in XY only (latitude and longitude). In general, the operation 550 can include perturbing parameter values in the metadata of the 2D real image (latitude, longitude, platform height, roll, pitch, yaw, or a combination thereof).

The accuracy factors can include a registration blunder metric, a number of ground control points (CPs) used in registration, a median pixel shift between tie points (TPs) of the 2D real image and a respective hypothesis image of the hypothesis images, a median pixel discrepancy when projecting the CPs, or a combination thereof. The registration blunder metric can be determined based on a ratio of a peak correlation value in a correlation score array to a second highest correlation value in the correlation score array, the correlation score array indicating correlation match between edges of the 3D points and edges of the hypothesis image. The registration blunder metric can be further determined based on an average phase match, measured at a registration offset associated with a peak correlation, of the correlation edges between a gradient of a hypothesis image and the gradient of the real image. The operation 558 can include replacing the image geometry of the metadata of the 2D real image with the image geometry of the selected best hypothesis metadata.

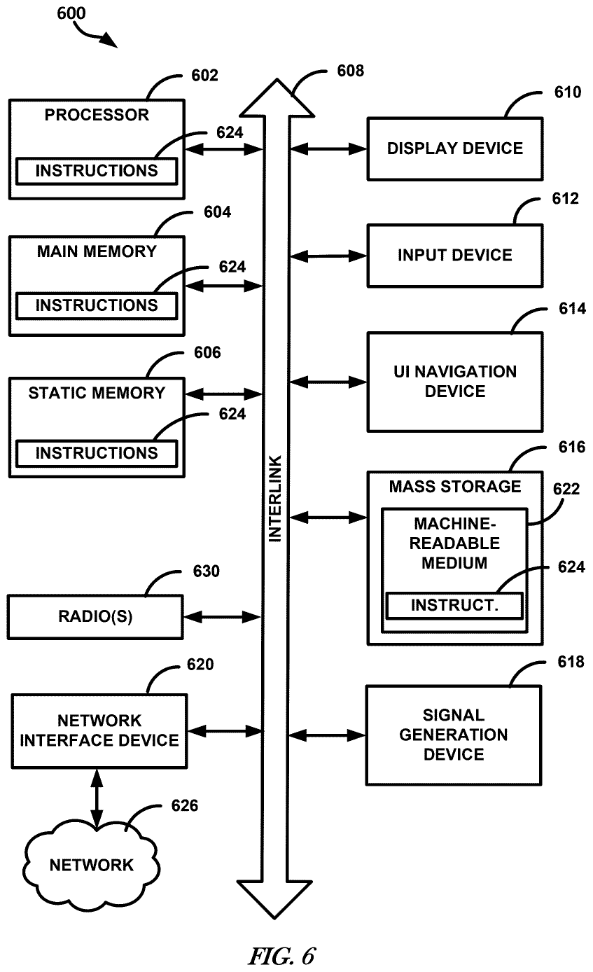

FIG. 6 illustrates, by way of example, a block diagram of an embodiment of a machine in the example form of a computer system 600 within which instructions, for causing the machine to perform any one or more of the methodologies discussed herein, may be executed. One or more of the components or operations of the method 100, method 500 can be implemented using or can include one or more components of the system 600. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a mass storage unit 616, a signal generation device 618 (e.g., a speaker), a network interface device 620, and a radio 630 such as Bluetooth, WWAN, WLAN, and NFC, permitting the application of security controls on such protocols.

The mass storage unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### EXAMPLE EMBODIMENTS

Example 1 includes a method for registration of a two dimensional (2D) real image to a three dimensional (3D) point set, the method comprising generating, based on metadata the 2D real image, hypotheses metadata, the hypotheses metadata for different corresponding image geometries, the different corresponding image geometries corresponding to different image platform locations, generating, based on respective hypothesis metadata of the hypotheses metadata, hypothesis images for different platform locations,, registering the 2D real image and the hypothesis images to the 3D point set, selecting, based on one or more accuracy factors, the hypothesis image of the hypotheses images that has a best registration to the 3D point set resulting in a selected best hypothesis, and altering the metadata of the 2D real image based on the geolocation of the selected best hypothesis metadata.

In Example 2, Example 1 further includes, wherein generating the hypothesis images includes altering a parameter value in the metadata of the 2D real image to alter the image geometries.

In Example 3, Example 2 further includes, wherein the perturbed parameter values include platform position (latitude, longitude).

In Example 4, Example 3 further includes, wherein the perturbed parameter values includes platform position in XY and Z(latitude and longitude, platform height), and platform orientation (roll, pitch, yaw), or a combination thereof.

In Example 5, at least one of Examples 1-4 further includes, wherein the accuracy factors include a registration blunder metric, a number of ground control points (CPs) used in registration, a median pixel shift between tie points (TPs) of the 2D real image and a respective hypothesis image of the hypothesis images, a median pixel discrepancy when projecting the CPs, or a combination thereof.

In Example 6, Example 5 further includes, wherein the registration blunder metric is determined based on a ratio of a peak correlation value in a correlation score array to a second highest correlation value in the correlation score array, the correlation score array indicating correlation match between edges of the 3D points and edges of the hypothesis image.

In Example 7, Example 6 further includes, wherein the registration blunder metric is further determined based on an average phase match, measured at a registration offset associated with a peak correlation, of the correlation edges between a gradient of a hypothesis image and the gradient of the real image.

In Example 8, at least one of Examples 1-7 further includes, wherein altering the metadata of the 2D real image based on the geolocation of the selected hypothesis image includes replacing the image geometry of the metadata of the 2D real image with the image geometry of the selected best hypothesis image.

Example 9 includes a non-transitory machine-readable medium including instructions that, when executed by a machine, cause the machine to perform the method of one of Examples 1-8.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method for registration of a two dimensional (2D) real image to a three dimensional (3D) point set, the method comprising:
generating, based on metadata of the 2D real image, hypotheses metadata, different hypothesis metadata of the hypotheses metadata corresponding to different image geometries, the different image geometries corresponding to different image platform locations;
generating, based on respective hypothesis metadata of the hypotheses metadata, hypothesis images for different platform locations;
registering the 2D real image and the hypothesis images to the 3D point set;
selecting, based on one or more accuracy factors, the hypothesis image of the hypothesis images that has a best registration to the 3D point set resulting in a selected hypothesis image; and
altering the metadata of the 2D real image based on the image geometry of the metadata of the selected hypothesis image.

2. The method of claim 1, wherein generating the hypothesis images includes altering a parameter value in the metadata of the 2D real image to alter the image geometries.

3. The method of claim 2, wherein the parameter value includes latitude, longitude, platform height, roll, pitch, yaw, or a combination thereof.

4. The method of claim 3, wherein the parameter value includes latitude and longitude.

5. The method of claim 1, wherein the accuracy factors include a registration blunder metric, a number of ground control points (CPs) used in registration, a median pixel shift between tie points (TPs) of the 2D real image and a respective hypothesis image of the hypothesis images, a median pixel discrepancy when projecting the CPs, or a combination thereof.

6. The method of claim 5, wherein the registration blunder metric is determined based on a ratio of a peak correlation value in a correlation score array to a second highest correlation value in the correlation score array, the correlation score array indicating correlation match between edges of the 3D points and edges of the hypothesis image.

7. The method of claim 6, wherein the registration blunder metric is further determined based on an average phase match, measured at a registration offset associated with a peak correlation, of the correlation edges between a gradient of a hypothesis image and the gradient of the real image.

8. The method of claim 1, wherein altering the metadata of the 2D real image based on the image geometry of the selected hypothesis image includes replacing the image geometry of the metadata of the 2D real image with the image geometry of the selected hypothesis image.

9. A non-transitory machine-readable medium including instructions that, when executed by a machine, cause a machine to perform operations for registration of a two dimensional (2D) real image to a three dimensional (3D) point set, the operations comprising:
generating, based on metadata of the 2D real image, hypotheses metadata, different hypothesis metadata of the hypotheses metadata corresponding to different image geometries, the different image geometries corresponding to different image platform locations;
generating, based on respective hypothesis metadata of the hypotheses metadata, hypothesis images for different platform locations;
registering the 2D real image and the hypothesis images to the 3D point set;
selecting, based on one or more accuracy factors, the hypothesis image of the hypothesis images that has a best registration to the 3D point set resulting in a selected hypothesis image; and
altering the metadata of the 2D real image based on the image geometry of the metadata of the selected hypothesis image.

10. The non-transitory machine-readable medium of claim 9, wherein generating the hypothesis images includes altering a parameter value in the metadata of the 2D real image to alter the image geometries.

11. The non-transitory machine-readable medium of claim 10, wherein the parameter value includes latitude, longitude, platform height, roll, pitch, yaw, or a combination thereof.

12. The non-transitory machine-readable medium of claim 11, wherein the parameter value includes latitude and longitude.

13. The non-transitory machine-readable medium of claim 9, wherein the accuracy factors include a registration blunder metric, a number of ground control points (CPs) used in registration, a median pixel shift between tie points (TPs) of the 2D real image and a respective hypothesis image of the hypothesis images, a median pixel discrepancy when projecting the CPs, or a combination thereof.

14. The non-transitory machine-readable medium of claim 13, wherein the registration blunder metric is determined based on a ratio of a peak correlation value in a correlation score array to a second highest correlation value in the correlation score array, the correlation score array indicating correlation match between edges of the 3D points and edges of the hypothesis image.

15. The non-transitory machine-readable medium of claim 14, wherein the registration blunder metric is further determined based on an average phase match, measured at a registration offset associated with a peak correlation, of the correlation edges between a gradient of a hypothesis image and the gradient of the real image.

16. The non-transitory machine-readable medium of claim 9, wherein altering the metadata of the 2D real image based on the image geometry of the selected hypothesis image includes replacing the image geometry of the metadata of the 2D real image with the image geometry of the selected hypothesis image.

17. A system comprising:
a memory including a three-dimensional (3D) point set of a first geographical region and a two-dimensional (2D) real image stored thereon;
processing circuitry coupled to the memory, the processing circuitry configured to:
generate, based on metadata of the 2D real image, hypotheses metadata, different hypothesis metadata of the hypotheses metadata corresponding to different image geometries, the different image geometries corresponding to different image platform locations;
generate, based on respective hypothesis metadata of the hypotheses metadata, hypothesis images for different platform locations;
register the 2D real image and the hypothesis images to the 3D point set;
select, based on one or more accuracy factors, the hypothesis image of the hypothesis images that has a best registration to the 3D point set resulting in a selected hypothesis image; and
alter the metadata of the 2D real image based on the image geometry of the metadata of the selected hypothesis image.

18. The system of claim 17, wherein generating the hypothesis images includes altering a parameter value in the metadata of the 2D real image to alter the image geometries.

19. The system of claim 18, wherein the parameter value includes latitude, longitude, platform height, roll, pitch, yaw, or a combination thereof.

20. The system of claim 19, wherein the parameter value includes latitude and longitude.
